(19) United States
(12) Patent Application Publication
(10) Pub. No.: US 2009/0061200 A1
(43) Pub. Date: Mar. 5, 2009

(54) Hydrophobic Insulation Material

(75) Inventors: Frank Hild, Long Beach, CA (US); David Biering, Brea, CA (US)

Correspondence Address: BROMBERG & SUNSTEIN LLP, 125 SUMMER STREET, BOSTON, MA, 02110-1618, US

(73) Assignee: TriStar Plastics Corporation, Shrewsbury, MA (US)

(21) Appl. No.: 11/849,054

(22) Filed: Aug. 31, 2007

(51) Int. Cl. B32B 5/18; C08J 7/18; C08J 9/38

(52) U.S. Cl. 428/304.4; 521/52; 522/147

(57) ABSTRACT

A hydrophobic foam insulation material is formed from a foam core material and a hydrophobic surface layer that is covalently bonded to the core, and is fully conformal to the core foam material. The surface layer is applied in a plasma. The foam material may have further been subjected to a reticulation process involving a plasma to reduce the density of the foam. Such hydrophobic insulation material is thus made lightweight, flexible, and suitable for aircraft applications.

### TECHNICAL FIELD

This invention relates to insulation, in particular, hydrophobic insulation for use in transportation equipment such as aircraft.

### BACKGROUND

Insulating materials that have a high thermal resistivity and high flame resistance, while at the same time being lightweight, are highly desirable in aircraft applications.

Polymer foams, and in particular polyimide foams, have been known for some time in the art as an insulating material suitable for aircraft applications. Polyimide foam material is suitable for use in aircraft. In one typical process for making polyimide foam, an alkyl diester of a tetracarboxylic acid is reacted with a diamine having formula NH2-R—NH2, where R is an aromatic group of between 5 and 16 carbons. The reactants are mixed and heated to form a polyimide, further heated to create a foam, then further heated to cure the foam. Said foams can be formed in sheets and blocks, and can be easily cut, shaped and molded to the particular forms of aircraft or other application to which it is used.

Many foams, and in particular polyimide foams, have the disadvantage of being hygroscopic. This ability to retain moisture degrades the insulating properties of the insulation material, as well as increases the weight of the polyimide foam as it attracts water. Thus, methods for decreasing the hydrophilic properties of polyimide foams are also desired by aircraft engineers.

There have been several approaches to producing an insulating product polyimide foam material to make it hydrophobic. One approach has been to seal the polyimide foam in a bag. This has the disadvantage of adding weight and bulk to the polyimide foam. Further, the bag is unlikely to have the same insulating qualities as the foam, thus increasing the weight while not adding to the insulating capacity of the material.

Other attempts to modify the foam have included spray and dip coatings. These methods, however, are not fully conformal to the polyimide surface. These coatings have a tendency to crack, craze, or break when the foam is subject to stresses, thus exposing the material to moisture at the points of cracking.

### SUMMARY OF THE INVENTION

In one aspect of the invention, an insulation material is made of a foam core material, which may have been subjected to a reticulation process to decrease its density, and a fully conformal hydrophobic surface layer. The foam core material may be a polyimide. In a particular embodiment, the surface layer is comprised of organosulfur, organosilicon, or fluorine-containing compounds chemically bonded to the exterior of the core material. The hydrophobic surface layer may have a thickness between 30 and 1000 angstroms. In related embodiments, the surface layer is polymeric with a concentration of sulfur, silicon, or fluorine to carbon in the range of 1.3 to 2.0. This material may be in the form of a sheet or block. In particular, the material may be made suitable for installation and use in an aircraft. In a preferred embodiment, this surface layer of the material has a contact angle between 110 and 130 degrees as measured by goniometry. In a related embodiment, this material has a thermal resistivity between 22 and 26 m K/W, as measured by ASTM C518 at a mean temperature of 24° C. In a related embodiment, this material has flame spread index between 1 and 3 as measured by ASTM E162. In another embodiment, this material has a flammability between 1 and 5, as measured of specific optical density of smoke under flaming conditions or pyrolytic conditions according to ASTM E662.

In another aspect of the invention, an insulation material is disclosed that is composed of a foam core material, and a hydrophobic surface layer formed by exposing the foam core material, which may be a polyimide, to a plasma formed from an organosilicon, organosulfur, or fluorine-containing compound.

In a more specific embodiment, the material is exposed to plasma by placing the foam in a chamber, evacuating the chamber, introducing gas containing an organosilicon, organosulfur, or fluorine-containing compound into the chamber, energizing the gas to form plasma and exposing the material to the plasma. The gas may contain a noble gas or hydrogen gas in addition to an organosilicon, organosulfur, or fluorine-containing compound. In a further related embodiment, the gas used to form the plasma is composed of perfluorohexane and tetrafluoromethane. The gas may be energized using an RF or DC generator. In a related embodiment, two electrodes in the chamber are used, and the foam is held away from the electrodes. The foam may be exposed for sufficient time to provide a surface layer with thickness between 30 and 1000 angstroms.

In a further related embodiment, the foam material may have been treated by a reticulation process to decrease its density by 20-30% compared with the starting foam material, as measured by a segment with dimensions of 6″ by 6″ by 1″. This reticulation process may be carried out in the same plasma treatment chamber by evacuating the chamber, introducing a reticulation gas comprising oxygen and at least one organosulfur, organosilicon, or fluorine-containing compound, energizing the gas to form a plasma, and exposing the polyimide foam to the plasma.

In a further aspect of the invention, there is a method for insulating a space with a hydrophobic insulation material by obtaining a segment of polyimide foam cut and shaped to the space to be filled, plasma treating the segment to form a hydrophobic layer on the segment, and providing the segment to be installed in the space. The insulation material may have been subjected to a reticulation treatment so as to decrease the density of the hydrophobic insulation material to 20-30% less than that of the starting segment, as measured by a segment with dimensions of 6″ by 6″ by 1″. In a specific embodiment, the space to be filled is the space between spacer members of an aircraft fuselage.

### BRIEF DESCRIPTION OF THE DRAWINGS

The foregoing features of the invention will be more readily understood by reference to the following detailed description, taken with reference to the accompanying drawings, in which:

FIG. 1 is a cutaway drawing of a portion of the insulating material in accordance with an embodiment of the present invention.

FIG. 2 is a longitudinal cross sectional drawing of the insulating material as installed in an aircraft fuselage in accordance with an embodiment of the present invention.

FIG. 3 is a schematic drawing of an apparatus embodying the method for producing an insulation material in accordance with an embodiment of the present invention.

FIG. 4 is a flow chart of a process for producing an insulation material in accordance with an embodiment of the present invention.

FIG. 5 is a flow chart of a process for installing an insulation material in an aircraft in accordance with an embodiment of the present invention.

FIG. 6 is a chart showing a FT-IR spectrum of an insulation material in accordance with an embodiment of the present invention.

FIG. 7 is a cross sectional drawing of a duct work using an insulation material in accordance with an embodiment of the present invention.

FIG. 8 is a cross sectional drawing of a pipe using an insulation material in accordance with an embodiment of the present invention.

### DETAILED DESCRIPTION OF SPECIFIC EMBODIMENTS

Insulation material in accordance with embodiments of the present invention is made resistant to water penetration by including a hydrophobic surface layer. For polyimide embodiments, the hydrophobic foam material has the advantage of having the same flame resistance as measured by ASTM methods as a prior art polyimide foam, but it is also resistant to water.

The insulation material according to an embodiment of the present invention may be used in aircraft or other transportation vehicles or for other purposes, such as insulation of air conditioning ducts, or insulation of hot water pipes. The material is particularly suitable for applications that have need for lightweight, water resistant insulation materials.

Furthermore, an insulation material according to an embodiment of the present invention may undergo a reticulation process using the same plasma processing equipment so that the resulting insulation material is even lighter than polyimide foam, while having the same flame and heat resistance as a polyimide foam and hydrophobic properties.

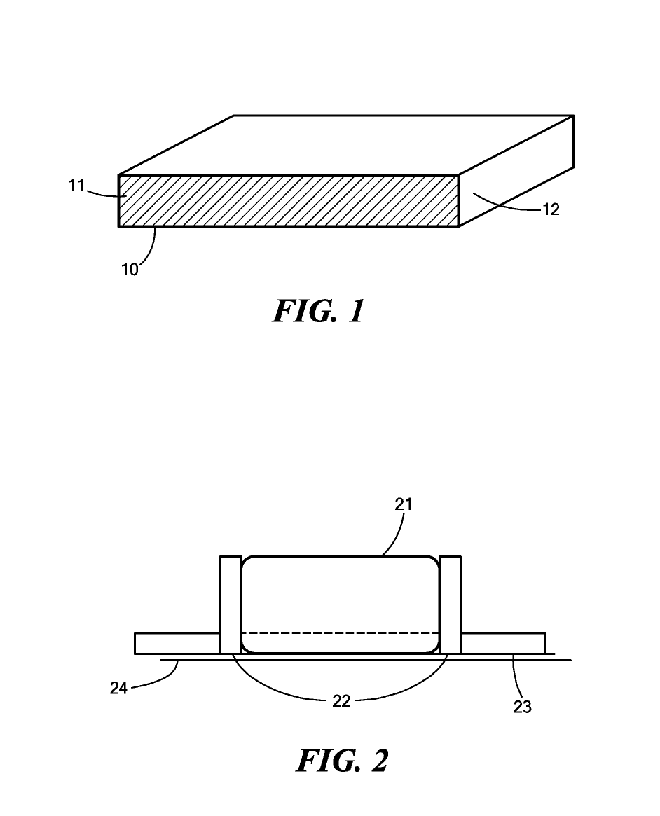

A block 10 of insulation material according to an embodiment of the present invention is shown in FIG. 1. This block is composed of a core material 11 (shown by the cutaway view) which can be a polyimide foam material as shown in 11 of FIG. 1. The material also comprises a hydrophobic surface layer 12 on all sides of the block that is covalently bonded to the core material 11. The layer 12, which entirely covers the core material 11, is a low energy surface which is in the order of about 30 to 1000 Angstroms thick and fully conformal. The remainder of the insulation material 10 is composed of a material similar to the prior art polyimide foam material.

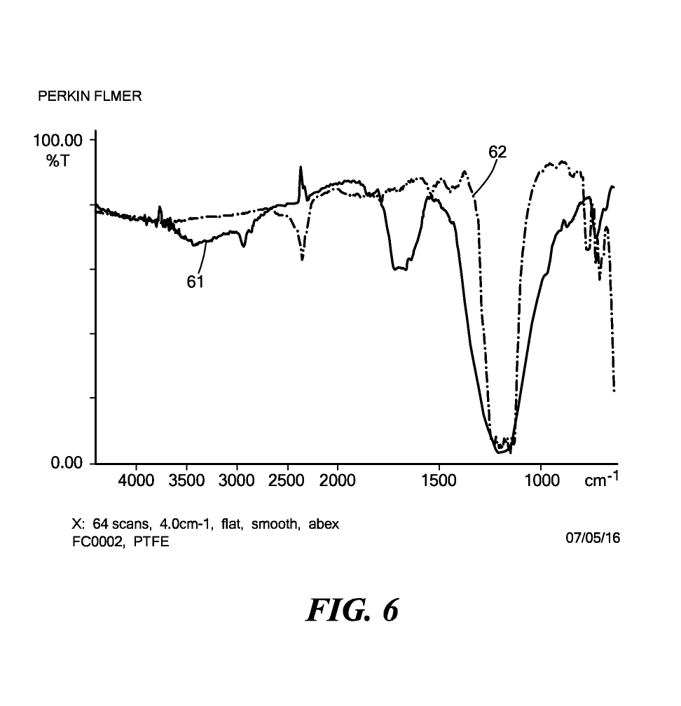

The surface layer is chemically formed by the reaction of the core material 11 in a plasma chemically bonding the core to at least one organosilicon, organosulfur, or fluorine-containing compound used in the plasma. A surface layer of a representative embodiment contains a ratio of fluorine, sulfur, or silicon to carbon of between 1.3 and 2, as may be measured by XPS spectroscopy. The surface layer 12 has the advantage over prior art polyimide insulation foam of being substantially hydrophobic, having a water contact angle of between 110 and 130 degrees as measured by goniometry, approximately equivalent to PTFE. The PTFE-like quality of this surface can be demonstrated by reference to Example 1 and FIG. 6.

### Example 1

### FT-IR Spectroscopy of a Hydrophobic Insulation Material

A sample of a hydrophobic insulation material according to the procedure of Example 8 was subjected to FT-IR spectroscopy. The FT-IR spectrum is shown as FIG. 6. The resulting spectrum 61 of the surface layer of the sample is superimposed to compare it with a spectrum of poly(tetrafluoroethylene) (PTFE) 62. As can be seen from this figure, the spectrum of the surface has several bands in common with PTFE, most notably a strong absorption at 1214 cm⁻¹ indicative of CF₂—CF₂ stretching.

The formation of the surface layer 12 does not degrade the desirable properties of the insulation material 10 with respect to a material composed simply of the core material 11. The thermal resistivity of the hydrophobic insulation material is substantially similar to that of a polyimide foam material of the prior art.

### Example 2

### Thermal Resistivity of a Sample of an Insulation Material

A sample of a hydrophobic insulation material having a fluorinated surface layer was prepared according to Example 8, an embodiment of the present invention. The thermal resistivity of this sample was measured at 24 (m K)/W, according to ASTM C518 at a temperature of 24 degrees C. This result is within the range of reported values of thermal conductivity for polyimide foams.

Furthermore, the flame resistance of the insulation material is substantially similar to that of a polyimide foam material of the prior art.

### Example 3

### Flammability of Hydrophobic Insulation Material

A comparison of flammability (as measured by specific optical density of smoke) between the prior art polyimide foam and hydrophobic insulation material according to the present invention was carried out. Samples of a hydrophobic insulation material according to the present invention were prepared according to the procedure of Example 8. Control samples of prior art polyimide foam material were also obtained. Samples of each were subjected to the flammability test of ASTM E662, and results were obtained for both the sample and the control sample of prior art polyimide foam. These results, which demonstrate that the desirable flammability properties of the hydrophobic insulation material are identical to a polyimide foam insulation material, are tabulated below.

| | | | Quantity measured and |
|---|---|---|---|
| | Sample | Control | testing protocol |
| Flammability Test, | 3 | 3 | Specific Optical Density of |
| pyrolytic | | | Smoke, Non-Flaming; |
| | | | ASTM E662 |
| Flammability Test, | 3 | 3 | Specific Optical Density of |
| flaming | | | Smoke, Flaming; ASTM E662 |

### Example 4

### Flame Spread Index

A comparison of flame spread index between the prior art polyimide foam and a hydrophobic insulation material according to the present invention was carried out. Samples of a hydrophobic insulation material according to the present invention was prepared according to the procedure of Example 8. Control samples of prior art polyimide foam material were also obtained. Samples of each were subjected to the radiant panel test of ASTM E162, and results were obtained for both the sample and the control sample of prior art polyimide foam. These results, which demonstrated that the desirable flame spread properties of the hydrophobic insulation material are identical to a polyimide foam insulation material, are tabulated below.

| Quantity measured | Sample | Control | Testing Protocol |
|---|---|---|---|
| Flame Spread Index | 2 | 2 | Radiant Panel; ASTM E162 |

The resulting insulation material, as stated previously, has the desirable properties of polyimide foam that make it useful in aircraft applications. However, this foam has the substantial advantage over a polyimide foam in terms of its hydrophobicity, as shown by the high contact angle of the surface of the material. This in turn leads to a high water resistance of the material relative to a polyimide foam. In essence, the foam maintains its lightweight character in the face of substantial exposure to moisture, as demonstrated in the following examples.

### Example 5

### Water Resistance as Measured by Float Test

A sample of a hydrophobic insulation material according to the present invention prepared according to the procedure of Example 8, and a control sample of polyimide foam used as starting material for the insulation material of this invention, both having a sample size of 7″×7″ by 1″, were weighed initially, allowed to float on distilled water for a period of 48 hours, and then reweighed. The starting and final weights for sample #2 and the control sample are listed below.

| | | | Percentage of |
|---|---|---|---|
| | | Weight After | initial weight in |
| Sample ID | Initial Weight (g) | Float Test (g) | absorbed water |
| 2 | 4.529 | 4.536 | 0.15% |
| Control | 5.397 | 8.734 | 61.8% |

The control sample absorbed 61.8% of its own weight in water, while sample #2 gained a negligible 0.15% percentage in absorbed water.

### Example 6

### Water Resistance as Measured by Soak Test

A sample of a hydrophobic insulation material of the present invention prepared according to the procedure of Example 8, and a control sample of polyimide foam used as starting material for the insulation material of this invention, both having a sample size of 6″×6″ by 1″, were weighed initially, submerged in distilled water at a depth of three inches for a period of 24 hours, and reweighed. The starting and final weights for the sample and the control are listed below.

| | | | Percentage of |
|---|---|---|---|
| | | Weight After | initial weight in |
| Sample ID | Initial Weight (g) | Soak Test (g) | absorbed water |
| 1 | 3.114 | 3.91 | 25.6% |
| Control | 3.815 | 11.007 | 188.5% |

The control sample absorbed 188.5% of its own weight in water, while the sample gained only 25.6% percentage in absorbed water.

As a further advantage of embodiments of this insulation, the formation of the surface layer 12 by treating the polyimide foam is fully compatible with a plasma reticulation process, which has the advantage of making the hydrophobic insulation material more lightweight (a very important consideration in aircraft applications) than a polyimide insulation material. As illustrated in Example 7, the hydrophobic insulation material of the present invention, depending on the size and length of treatment time, can be reduced in density from a similarly sized segment of polyimide foam by approximately 20 to 30% without degrading the insulating properties of the material and without degrading the hydrophobic characteristic of the material.

### Example 7

### Mass Reduction of Insulation Material

The density of a segment of a hydrophobic insulation material according to the present invention as compared to the same size segment of polyimide foam material was determined. A 6″×6″×1″ sample of a polyimide foam material suitable for insulation was determined to have a mass of 4.212 g, thus having a calculated density of 0.0072 g/cc. The segment of foam material was treated by the procedure of Example 8 to produce a hydrophobic insulation material with additional reticulation treatment in accordance with an embodiment of the present invention. The sample was determined to have the same dimensions, and thus volume, as the polyimide foam material from which it was made, but the weight of the sample was measured to be 3.114 g, giving a calculated density of 0.0053 g/cc. This is a 26.1% reduction in density from a similarly sized polyimide foam material. The hydrophobic insulation material, not only having the insulation and flame resistance of other polyimide foams, also is even more lightweight than similar polyimide foams, as well as having water resistant properties.

In a typical application, as illustrated by the longitudinal cross sectional drawing of FIG. 2, a segment 21 (such as a sheet or block) of a hydrophobic insulation material according to the present invention may be used to occupy the space between spacer members (those members that support the skin 24 and run latitudinally along the axis of the aircraft) 22 of an aircraft fuselage and provide efficient insulation for the aircraft. Further, the insulation material, being flexible, can be forced into place to fit around the longitudinal stringers (frame members that run longitudinally along the aircraft fuselage and support the skin 24) and thus to occupy the space between the longitudinal stringer members 23.

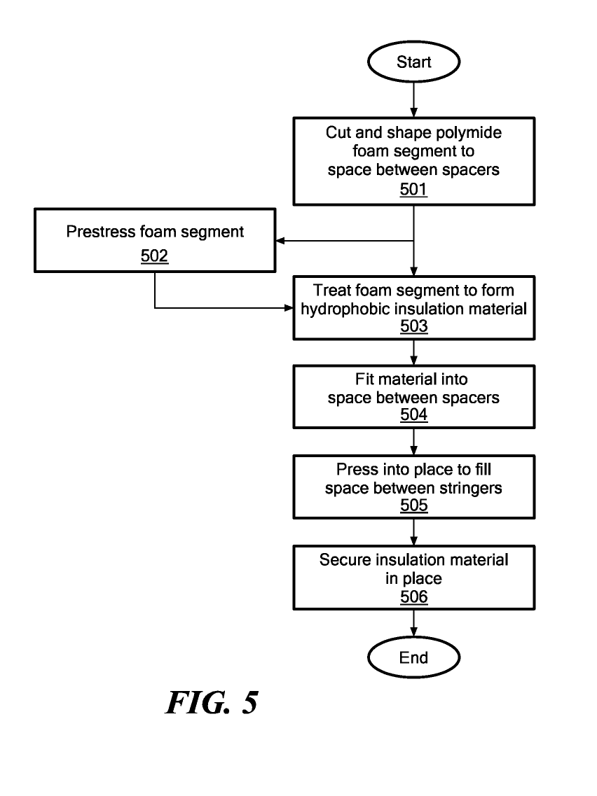

A process for installing insulation in accordance with an embodiment of this invention follows the steps illustrated in FIG. 5. In step 501, a polyimide foam material is cut and shaped into segments 21 that will fit into the spaces between spacer members (the latitudinal members of an aircraft that support the skin) 22. Each segment 21 may optionally be prestressed by mechanically pressing the segment to increase its flexibility as step 502. The segment 21 may then be subject to plasma processing (described below) in step 503 to convert the segment 21 into a hydrophobic insulation material according to the present invention. In a related embodiment, the sheet or block 21 of the hydrophobic insulation material may then be wrapped in a polymer film such as PEEK (polyether ether ketone) or PVDF (polyvinylidene fluoride), in order to further augment the water resistance and durability of the material. In step 504, the segment 21 is then fitted into the space between mechanical spacer members 22 such as those in an aircraft fuselage. The insulation material, having a hydrophobic surface that is both flexible and conformal, can then be pressed in place in such a manner, in step 505, so as to also occupy the space between the longitudinal stringer members (the support members that run longitudinally along the aircraft fuselage to support the skin) 23 and the skin 24 of the aircraft fuselage. Because the hydrophobic surface layer is flexible and conformal, it can be forced into place without harming its hydrophobic properties due to surface cracking or crazing. The hydrophobic insulation material may be further secured in place, by step 506, between the frame members by using straps drawn between frame members.

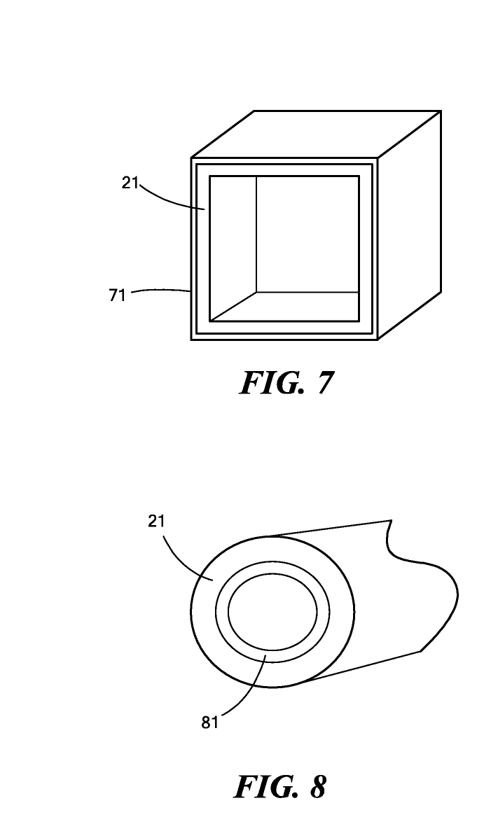

In another embodiment of the invention, as illustrated in FIG. 7, a segment 21 of polyimide foam material may be formed into a sheet suitable for lining of ducts. Like the fuselage lining, the polyimide foam segment is then converted via a plasma process in accordance with the present invention into a hydrophobic insulation material according to the present invention. The insulation material segment 21, being fully flexible and resistant to cracking, can easily be used to line ductwork 71 without losing its hydrophobic properties in shaping to the interior of the ducts. An adhesive may be used to bind the material segment 21 to the ductwork 71.

In a further related embodiment, as illustrated in FIG. 8, a segment 21 of polyimide foam material may be cut and shaped into a sheet suitable for wrap insulation of piping, where the high thermal resistivity of a foam is desirable, and where water resistance is also desirable. The sheet segment 21 is treated by a plasma process to convert the segment into a hydrophobic insulation material in accordance with the present invention. The flexible sheet may be used to wrap a hot water pipe 81. The material retains its hydrophobic properties even when bent to wrap a pipe.

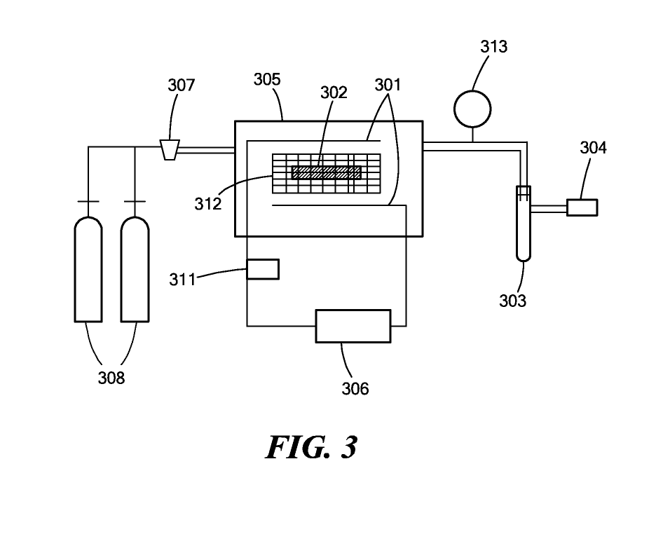

A process that may be employed in exposing a polyimide foam material to a plasma formed from a gas having organosilicon, organosulfur, or fluorine-containing compound to produce a hydrophobic insulation material in accordance with the present invention is illustrated by the apparatus shown in FIG. 3. FIG. 3 shows a chamber 305 in which a segment 302 of a polyimide foam insulating material is placed. This segment of foam material may be formed and shaped to the appropriate conformation for use. The segment may also be prestressed (by applying pressure the foam segment to increase flexibility) before reacting.

As shown in the figure, a pure organosilicon, organosulfur or fluorine-containing gas (such as fluorine or fluorinated hydrocarbon) or a mixture of such a gas and inert gas or gases such as helium, argon, neon or the like is supplied from tanks 308 through regulated mass flow meter valve 307. The fluorine-containing gas may be selected from saturated perfluoro compounds having the general structure of CₓY₂ₓ₊₂, unsaturated perfluoro compounds having the general structure of CₓYₓ₊₂, and perfluoro cyclic compounds. Examples of suitable monomers include hexafluoropropylene oxide, tetrafluoroethylene, hexafluorocyclopropane, octafluorocyclobutane, perfluorooctanesulfonyl fluoride, octafluoropropane, trifluoromethane, difluoromethane, difluorodichloromethane, difluorodibromomethane, difluorobromomethane, difluorochloromethane, trifluorochloromethane, tetrafluorocyclopropane, tetrachlorodifluorocyclopropane, trichlorotrifluoroethane, or dichlorotetrafluorocyclopropane. Derivatives of tetrafluoroethylene are also useful, including tetrafluoroethylene-hexafluoropropylene copolymers, tetrafluoroethylene-perfluorovinyl ether copolymers (e.g., copolymers of tetrafluoroethylene with perfluoropropyl vinyl ether), tetrafluoroethylene-ethylene copolymers, and perfluorinated ionomers (e.g., perfluorosulfonate ionomers; perfluorocarboxylate ionomers).

As further alternate embodiments, the source gas can be formed by one or a combination of organosilane compounds. Examples of such compounds that may be used in forming the hydrophobic insulation material include hexamethylcyclotrisiloxane, octamethylcyclotetrasiloxane, 1,3,5-trivinyl-1,3,5-trimethylcyclotrisiloxane, 1,3,5,7-tetravinyl-1,3,5,7-tetramethylcyclotrisiloxane, 3-(N-allylamino)propyltrimethoxysilane, allyldichlorosilane, allyldimethoxysilane, allyldimethylsilane, allyltrichlorosilane, allyltrimethoxysilane, allyltrimethylsilane, bis(dimethylamino)vinylmethylsilane, para-(t-butyldimethylsiloxy)styrene, decamethylcyclopentasiloxane, diethylsilane, dimethylethoxysilane, dimethylsilane, divinyldimethylsilane, divinyltetramethyldisilane, 1,3-divinyltetramethyldisiloxane, ethyltrimethoxysilane, hexamethyldisiloxane, 1,1,3,3,5,5-hexamethyltrisiloxane, hexavinyldisiloxane, methyltriethoxysilane, methyltrimethoxysilane, methylsilane, tetraethoxysilane, tetraethylcyclotetrasiloxane, tetraethylsilane, tetramethoxysilane, 1,1,3,3-tetramethyldisiloxane, tetramethylsilane, tetravinylsilane, trimethylsilane, vinyldimethylsilane, vinylmethylbis(trimethylsiloxy)-silane 3-vinylheptamethyltrisiloxane, vinylmethyldiethoxysilane, vinyloxytrimethylsilane, vinylpentamethyldisiloxane, vinyltetramethyldisiloxane, vinyltrimethoxysilane, or vinyltrimethylsilane.

The source of the fluorinated ions and radicals, i.e., fluorine gas, sulfur hexafluoride, hexafluoroethane, tetrafluoromethane, perfluoro-cyclic compounds, perfluoro-aliphatic compounds, perfluoro-organosilane compounds, or chloroperfluoro compounds are connected to and are capable of flowing into reaction chamber 305 through flow meter valves 307.

In one preferred embodiment, a two gas system is used, composed of perfluorohexane and tetrafluoromethane gases in approximately 50:50 proportion.

Typically, the reaction chamber 305 is constructed out of aluminum, although steel, stainless steel, quartz or borosilicate glass can be used. Also, either in the chamber 305 or external to the chamber are one or more electrodes 301. The foam may be suspended between the electrodes 301 for direct plasma treatment or at a location away from the electrodes for indirect plasma treatment. The configuration of the chamber 305 and the design of the electrodes 301 can be changed to accommodate various polyimide foam shapes (i.e. tubes, arcs, bars, sheets, cylinders) used in applications such as aircraft. Further, the segment 302 may be held in a metal cage 312, known as a Faraday cage, to protect the segment from damage caused by ablation by the ions produced in the process. A radio frequency generator 306 is connected to a matching network 311. As an alternative embodiment, the RF generator can be replaced by a direct current or microwave generator.

The reaction chamber is also connected to a foreline trap 303 leading to a vacuum pump 304 that is capable of reducing the pressure in the chamber to 100 mT. A pressure gauge 313 between the chamber 305 and foreline trap 303 measures the pressure inside the chamber.

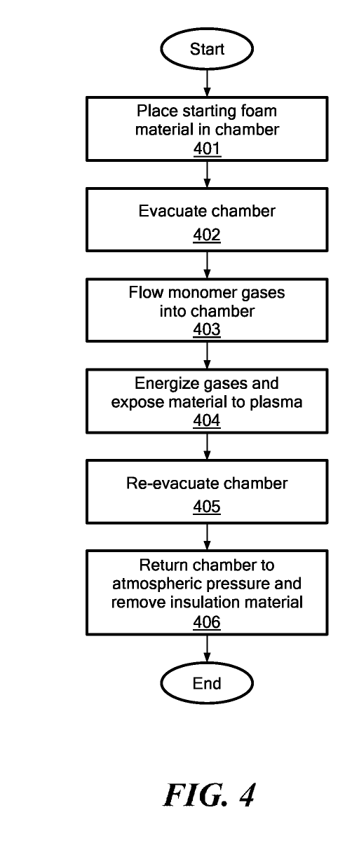

A flow chart outlining a procedure to produce a hydrophobic insulation material in accordance with the present invention is illustrated by FIG. 4. A segment 302 of polyimide foam starting material is placed in the chamber 305 in step 401. Then, in step 402, the reaction chamber 305 is evacuated through the foreline trap 303, using a vacuum pump 304. In order to achieve the desirable results, it is desirable that the total pressure within the chamber 305 be maintained at less than about, preferably less than about 250 mTorr. Following the evacuation of step 402, the gas or gas mixture from tank or tanks 308 is set to flow into the chamber 305 at a specific rate via mass flow meter valves 307 into the reaction chamber 305 as step 403. The gas is allowed to flow into the chamber 305 in order to carry out the reaction and is removed from the chamber by the vacuum pump 304 with the appropriate flow and restriction hardware to ensure the appropriate partial pressure, which is measured by the vacuum gauge 313. It is desirable to utilize flow rates in excess of about 10 mL/min (seem), preferably in excess of about 100 mL/min (sccm).

Once the flow of gases in the chamber 305 is maintained at the desired level, the gases are subject to excitation by DC excitation (or by radio frequency or microwave excitation) through the electrodes (or by radio frequency or microwave excitation) in step 404. While the interior of the chamber 305 is being energized through electrodes 301, the surface of the polymer segment 302 is contacted with ions and/or radicals comprising fluorine and/or fluorinated carbon as a cold plasma. The cold plasma comprises a glow discharge formed by the radio frequency (RF) or direct current (DC) excitation. The glow discharge comprises species such as ions and radicals of fluorine, carbon-difluoride and/or carbon-trifluoride, and other species created by the excitation of the fluorocarbon, organosulfur, or organosilicon compound in the chamber. The glow discharge is maintained at a sufficiently high energy to form the desired ions or radicals while at the same time avoiding high temperatures which would degrade the surface of the polymer being treated. The polyimide foam segment 302 is exposed to the gas plasma for a suitable time to effect substantially complete formation of a hydrophobic surface layer 22. The position of the sample holder portion can be varied with respect to the electrode or electrode configurations (external or internal). The desired time for completion is based on the size of the polymer segment 302 in the vacuum chamber 305. The time for energizing the sample is preferably between 5 and 15 minutes.

The plasma in the chamber 305 can be produced by any conventionally available means such as radio frequency excitation, microwave excitation or with electrodes 301. The reaction is conducted substantially free of species such as oxygen or nitrogen which would react in competition with the fluorine-containing radicals or ions. It is desirable to set the high direct current voltage in excess of 10 W, preferably in between 500 and 1000 W. Suitable plasmas can also be formed with a radio frequency discharge operating between about 10 kHz to 20 MHz and about 10 to 2500 W or with a microwave discharge operating between about 10⁴ to 10⁶ megahertz and about 10 to 1000 W. This wattage is based upon a 14.75 inch×14.75 inch×30 inch rectangular aluminium chamber 305 and may be increased for a larger reactor.

After the plasma treatment has completed, the source of excitation is turned off, and the chamber is reevacuated of all the gases used in the treatment in step 405. The chamber 305 is then returned to atmospheric pressure in step 406, and the segment 302, now the finished hydrophobic insulation material, may be removed from the chamber.

The plasma treating equipment that may be used to form a hydrophobic material in accordance with the present invention may also be advantageously used to perform a second process to reticulate the foam core material, and thus reduce the resulting density of a hydrophobic insulation material. This additional reticulation treatment may be carried out prior to the treatment used in forming the hydrophobic surface. The resulting foam has an even lower density than polyimide foam, is hydrophobic, and has the insulating properties of polyimide foam.

Like the hydrophobic layer process, the polyimide foam is placed in the chamber 305 and evacuated through the foreline trap 303, using a vacuum pump 304. In order to achieve the desirable results, it is desirable that the total pressure within the chamber 305 be maintained at less than about, preferably less than about 250 mTorr.

Following evacuation, a gas or gas mixture from tank or tanks 308 is set to flow into the chamber 305 at a specific rate via mass flow meter valves 307. This mixture of gas will be predominantly composed of oxygen (O₂), with a smaller amount of a organosulfur, organosilicon, or fluorine-containing gas such as CF₄. Other compounds as listed above may be used for this step in addition to oxygen. It is desirable to utilize flow rates in excess of about 10 mL/min (seem), preferably in excess of about 100 mL/min (seem).

Once the flow of gases in the chamber 305 is maintained at the desired level, the gases are subject to excitation by DC or RF excitation through the electrodes. While the interior of the chamber 305 is being energized through electrodes 301, the surface of the polymer segment 302 is contacted with ions and/or radicals comprising fluorine and/or fluorinated carbon as a cold plasma. The polyimide foam segment 302 is exposed to the gas plasma for a suitable time to effect substantially complete reticulation of the segment. The position of the sample holder portion can be varied with respect to the electrode or electrode configurations (external or internal). The desired time for completion is based on the size of the polymer segment 302 in the vacuum chamber 305. The foam may be energized so as to achieve a 20-30% reduction in density (as measured by a segment of 6″ by 6″ by 1″) without harming the insulating or hydrophobic properties of the segment. The time for energizing the sample is preferably between 15 and 45 minutes. After energizing the foam in this manner, the chamber is reevacuated, and the hydrophobic layer process of FIG. 4 may be carried out on the material.

### Example 8

### Production of a Reticulated Hydrophobic Insulation Material

A segment of a polyimide foam was placed in a chamber maintained at 35° C. After evacuating the chamber to 100 mTorr using a Leybold D65 and WSU251 blower, the chamber, two gases were simultaneously metered into the chamber: Oxygen (O₂) was metered into the chamber at a rate of 200 mL/min, and tetrafluoromethane (CF₄) was metered into the chamber at a rate of 33 mL/min. the chamber pressure was maintained at 200 mTorr through the use of the vacuum system. The chamber was then energized by radio frequency excitation of 1000 Watts at 40 kHz using two electrodes suspended such that the polyimide segment was between the two electrodes, but not in contact with the electrodes. The chamber was energized for a period of 30 minutes after which the hydrophobic process occurred. The chamber was reevacuated and perfluorohexane (C₆H₁₄) was metered into the chamber at a rate of 200 mL/min, and tetrafluoromethane (CH₄) was metered into the chamber at a rate of 200 mL/min. The chamber was maintained at a pressure of 200 mTorr through the use of the vacuum system. The chamber was then energized by radio frequency excitation of 500 Watts at 40 kHz, using two electrodes suspended such that the polyimide segment was between the electrodes, but not in contact with the electrodes. The chamber was energized for a period of 5 minutes, after which the chamber was evacuated, then returned to atmospheric pressure. The samples produced by this process were used for Examples 1-7 of this specification.

We claim:

1. An insulation product comprising:
a foam core material; and
a hydrophobic surface layer fully conformal to the foam core material.

2. An insulation product according to claim 1, wherein said foam core material has been subjected to a reticulation process to decrease its density.

3. An insulation product according to claim 1 wherein said foam core material is a polyimide.

4. An insulation product according to claim 1 that is suitable for installation and use in an aircraft.

5. An insulation product according to claim 1 wherein said product is in the form of a sheet or a block.

6. An insulation product according to claim 1 wherein said hydrophobic surface layer has a contact angle between 110 and 130 degrees.

7. An insulation product according to claim 1, wherein said insulation product has a thermal resistivity between 22 and 26 m K/W, as measured by according to ASTM C518 at a mean temperature of 24° C.

8. An insulation product according to claim 1, wherein said insulation product has a flame spread index between 1 and 3 as measured according to ASTM E162.

9. An insulation product according to claim 1, wherein said insulation product has a flammability of between 1 and 5, as measured by the specific optical density of smoke according to ASTM E662 under pyrolytic conditions.

10. An insulation product according to claim 1, wherein said insulation product has a flammability of between 1 and 5, as measured by the specific optical density of smoke according to ASTM E662 under flaming conditions.

11. An insulation product according to claim 1, wherein said surface layer is a polymeric layer that has a concentration of sulfur, silicon, or a fluorine in the range of 1.3 to 2.0.

12. An insulation product according to claim 1, wherein said surface layer comprises organosulfur, organosilicon or fluorine-containing compounds chemically bonded to the exterior of said foam core material.

13. An insulation product according to claim 1, wherein said hydrophobic surface layer has a thickness between 30 and 1000 angstroms.

14. An insulation product comprising:
a foam core material; and
a hydrophobic surface layer formed by exposing the foam core material to a plasma,
and wherein said plasma is formed from a gas comprising at least one organosilicon, organosulfur or fluorine-containing compound.

15. An insulation product according to claim 14 wherein said foam core material is a polyimide.

16. An insulation product according to claim 14, wherein said exposing the foam core material to a plasma is carried out by
a. holding the foam core material in a chamber;
b. evacuating the chamber to a reduced pressure;
c. introducing a gas into the chamber, where such gas comprises at least one organosulfur, organosilicon or fluorine-containing compound;
d. energizing the gas to form a plasma; and
e. exposing the foam core material to the plasma.

17. An insulation product according to claim 14, wherein said foam core material has been reticulated by
a. holding the foam core material in a chamber;
b. evacuating the chamber to a reduced pressure;
c. introducing a reticulation gas into the chamber, where such gas comprises oxygen;
d. energizing the gas to form a reticulation plasma; and
e. exposing the foam core material to the reticulation plasma.

18. An insulation product according to claim 14, wherein said plasma is formed from a gas comprising hydrogen or a noble gas in addition to at least one organosilicon, organosulfur or fluorine-containing compound.

19. An insulation product according to claim 14, wherein said plasma is formed from a gas comprising perfluorohexane and tetrafluoromethane.

20. An insulation product according to claim 14, wherein the foam core material was subjected to a reticulation process.

21. An insulation product according to claim 20, wherein the polyimide foam decreases in density by 20 to 30% compared to the polyimide foam core material, as measured by a segment with dimensions of 6″ by 6″ by 1″.

22. A method for insulating a space with a hydrophobic insulation material, comprising:
a. receiving a segment of polyimide foam cut or shaped to the space to be insulated;
b. treating the segment using a plasma to form a hydrophobic surface layer on said segment;
c. providing the segment for installation into the space to be insulated.

23. A method for insulating a space according to claim 22, wherein the segment has been subjected to a reticulation process so as to cause the segment to decrease in density by 20 to 30% compared to the polyimide foam, as measured by a segment with dimensions of 6″ by 6″ by 1″.

24. A method for insulating a space according to claim 22, wherein treating the segment using a plasma to form a hydrophobic surface layer comprises
a. holding the segment in a chamber;
b. evacuating the chamber to a reduced pressure;
c. introducing a gas into the chamber, where such gas comprises at least one organosulfur, organosilicon or fluorine-containing compound;
d. energizing the gas to form the plasma; and
e. exposing the segment to the plasma.

25. A method for insulating a space according to claim 22, wherein said space is the space between spacer members of an aircraft fuselage.
